(19) United States
(12) Patent Application Publication
(10) Pub. No.: US 2008/0095076 A1
(43) Pub. Date: Apr. 24, 2008

(54) NETWORK DEVICE AND LOAD ASSIGNING METHOD THEREOF

(75) Inventors: CHENG-CHIH KUO, Tu-Cheng (TW); SHIN-HSIN HSU, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/872,726

(22) Filed: Oct. 16, 2007

(30) Foreign Application Priority Data
Oct. 18, 2006 (CN) 200610063183.7

(51) Int. Cl. H04L 12/42

(52) U.S. Cl. 370/258

(57) ABSTRACT

A network device (10) communicates with other network devices with a plurality of loops, and includes a plurality of virtual ringing groups, a plurality of Ringer Equivalency Number (REN) loads (106), a receiving module (100), an assigning module (102), and a ringing module (104). Each virtual ringing group rings during an individually fixed ringing time interval. The REN loads are for generating ringing signals, and the number of REN loads is less than that of the loops. The receiving module receives a calling signal, and transmits the calling signal to one of the loops. The assigning module assigns the calling signal to one of the virtual ringing groups. The ringing module assigns one REN load to the loop with the calling signal according to the assigned virtual ringing group. A load assigning method is also provided.

### BACKGROUND

1. Field of the Invention

The present invention relates to network devices, and particularly to a network device with a plurality of Ringer Equivalency Number (REN) loads.

2. Description of Related Art

Nowadays, network devices such as voice gateways need to provide a Ringer Equivalency Number (REN) load for each loop formed in communications with other network devices. An REN load indicates a ringer load, and the number of REN loads in one network device indicates the maximum ringer loads in one telephone line. In the United States, one REN load equals one resistor of 6930 ohms in series with one capacitor of 8 uF. However, the greater the number of REN loads on for a phone line, the greater the likelihood that communications in the telephone line may be abnormal. Therefore, efforts of the carriers are to reduce the number of REN loads.

As far as conventional gateways are concerned, one gateway needs to deal with multiple loops, and for each loop there is one REN load. For example, one conventional gateway composed of 48 loops will require the use of 48 REN loads for proper operation.

However, in practical applications, not all the loops are working at the same time, therefore the conventional solution of one REN load for each loop is unnecessary, and increases the total ringing power consumption.

### SUMMARY

One aspect of the present invention provides a network device. The network device communicates with other network devices with a plurality of loops, and includes a plurality of virtual ringing groups, a plurality of Ringer Equivalency Number (REN) loads, a receiving module, an assigning module, and a ringing module. Each virtual ringing group rings during an individually fixed ringing time interval. The REN loads are for generating ringing signals, and the number of REN loads is less than that of the loops. The receiving module receives a calling signal, and transmits the calling signal to one of the loops. The assigning module assigns the calling signal to one of the virtual ringing groups. The ringing module assigns one REN load to the loop with the calling signal according to the assigned virtual ringing group.

Another aspect of the present invention provides a load assigning method. The load assigning method is used in a network device, and the network device communicates with other network devices with a plurality of loops. The load assigning method includes: providing a plurality of virtual ringing groups each ringing during an individually fixed ringing time interval, and a plurality of Ringer Equivalency Number (REN) loads for generating ringing signals, wherein the number of REN loads is less than that of the loops; receiving a calling signal; transmitting the calling signal to one of the loops; assigning the calling signal to one of the virtual ringing groups; and assigning one REN load to the loop with the calling signal according to the assigned virtual ringing group.

Other advantages and novel features will become more apparent from the following detailed description when taken in conjunction with the accompanying drawings, in which:

### BRIEF DESCRIPTION OF THE DRAWINGS

FIG. 1 is a block diagram of functional modules of a network device of an exemplary embodiment of the present invention;

FIG. 2 is a table showing ringing time intervals of a plurality of virtual ringing groups used by network device of FIG. 1;

FIG. 3 is a block diagram of functional modules of an assigning module of FIG. 1;

FIG. 4 is a chart showing ringing time intervals of a plurality of virtual ringing groups as in FIG. 3;

FIG. 5 is a flowchart of a load assigning method of another exemplary embodiment of the present invention; and

FIG. 6 is a detailed flowchart of the load assigning method of FIG. 5.

### DETAILED DESCRIPTION

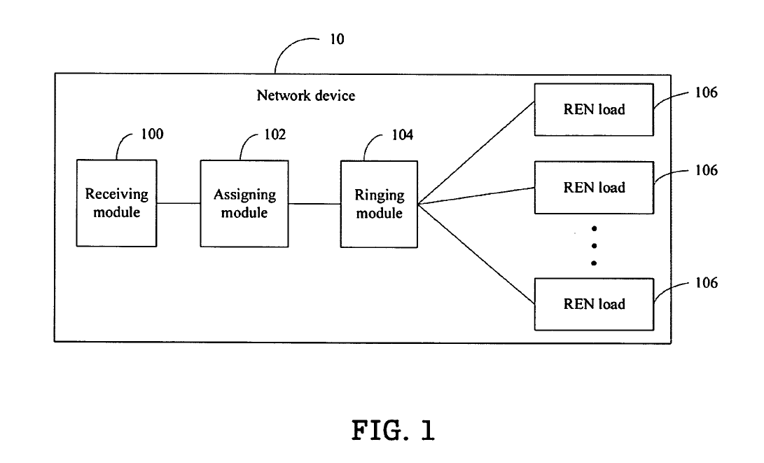

FIG. 1 is a block diagram of functional modules of a network device 10 of an exemplary embodiment of the present invention. In the exemplary embodiment, the network device 10 may be a voice gateway. The network device 10 communicates with other network devices with a plurality of loops, and predefines a plurality of virtual ringing groups. The network device 10 includes a receiving module 100, an assigning module 102, a ringing module 104, and a plurality of Ringer Equivalence Number (REN) loads 106. The REN loads 106 are used for generating ringing signals. The number of the loops is greater than that of the REN loads 106.

The receiving module 100 receives a calling signal from a user, and transmits the calling signal to one of the loops. The assigning module 102 assigns the calling signal to one of the virtual ringing groups. The ringing module 104 assigns one REN load 106 to the loop with the calling signal according to the assigned virtual ringing group.

In the exemplary embodiment, the network device 10 predefines the virtual ringing groups according to an application environment of the network device 10. For example, if the network device 10 has 48 loops and requires that the ringing signals ring for 1 second out of every 3 seconds, the network device 10 predefines three virtual ringing groups, one group for each one second segment in a three second period. Accordingly, each virtual ringing group can support up to 16 REN loads 106 at the same time, therefore a total of only 16 REN loads needs be employed for the network device 10.

In other embodiments, if the application environment of network device 10 requires that the ringing signals ring for 1 second out of every 2 seconds, the network device 10 predefines two virtual ringing groups and only 24 REN loads need be employed.

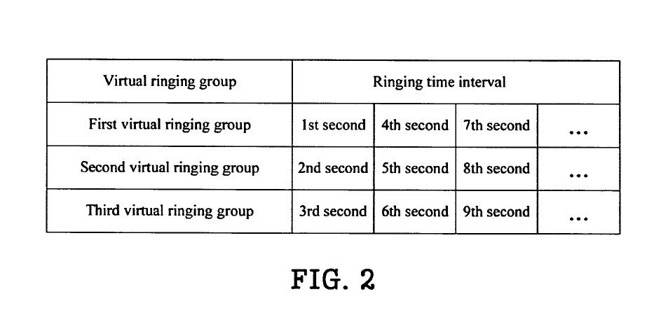

In this embodiment, referring to FIG. 2, the plurality of virtual ringing groups includes a first virtual ringing group, a second virtual ringing group, and a third virtual ringing group. Each virtual ringing group is used for ringing during an individually fixed ring time interval. In detail, the first virtual ringing group rings during the 1st second, the 4th second, the 7th second, etc. The second virtual ringing group rings during the 2nd second, the 5th second, the 8th second, etc. The third virtual ringing group rings during the 3rd second, the 6th second, the 9th second, etc.

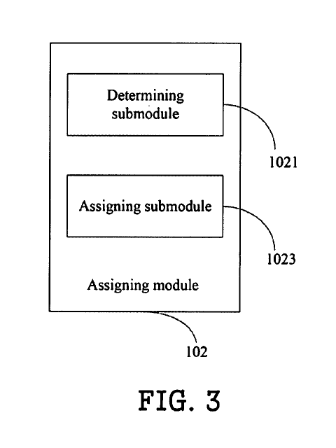

Referring also to FIG. 3, the assigning module 102 includes a determining submodule 1021 and an assigning submodule 1023.

The determining submodule 1021 determines whether all REN loads 106 of a current virtual ringing group have been assigned.

The assigning submodule 1023 assigns the calling signal to one of the virtual ringing groups according to the determined result of the determining submodule 1021.

In the exemplary embodiment, if all REN loads 106 of the current virtual ringing group have been assigned, the assigning submodule 1023 assigns the calling signal to a subsequent virtual ringing group.

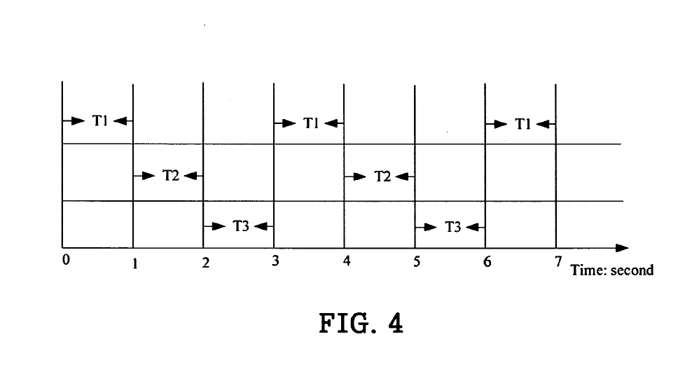

Referring to FIG. 4, T1 indicates the ringing time interval of the first virtual ringing group, T2 indicates the ringing time interval of the second virtual ringing group, and T3 indicates the ringing time interval of the third virtual ringing group. In this example, the network device 10 communicates with other network device and forms 48 loops, and each virtual ringing group includes at most 16 REN loads 106. If the receiving module 100 receives a calling signal in the 0.2th second, then the current virtual ringing group is the first virtual ringing group because the 0.2th second is inside the ringing time interval of T1. Therefore, the determining submodule 1021 determines whether all 16 REN loads of the first virtual ringing group have been assigned.

If all 16 REN loads of the first virtual ringing group have been assigned, the assigning submodule 1023 assigns the calling signal to the second virtual ringing group. Then the ringing module 104 waits for 0.8 seconds. The 0.8 seconds is the time difference between a starting time of T2 and the time when the calling signal is received. The ringing module 104 then assigns one REN load 106 to the loop with the calling signal, and then removes the REN load 106 from the loop after the REN load 106 is in the loop for 1 second. After 2 seconds the ringing module 104 assigns the REN load 106 to the loop again, and then removes the REN load 106 from the loop after the REN load 106 is in the loop for 1 second, and so on. In other words, the ringing module 104 assigns the REN load 106 to the loop with the calling signal according to the ringing time interval of the second virtual ringing group.

If not all REN loads 106 of the current virtual ringing group have been assigned, the assigning submodule 1023 assigns the calling signal to the current virtual ringing group.

Referring to FIG. 4 again, if the receiving module 100 receives a calling signal in the 0.2th second, the current virtual ringing group is the first virtual ringing group because the 0.2th second is inside the ringing time interval of T1. If not all 16 REN loads of the first virtual ringing group have been assigned, the assigning submodule 1023 assigns the calling signal to the first virtual ringing group. The ringing module 104 assigns one REN load 106 to the loop with the calling signal according to the ringing time interval of the first virtual ringing group. In detail, the ringing module 104 assigns one REN load 106 to the loop, and then removes the REN load 106 from the loop after the REN load 106 is in the loop for 0.8 second. After 2 more seconds have passed, the ringing module 104 assigns the REN load 106 to the loop again, and then the REN load 106 is in the loop for 1 second, and so on.

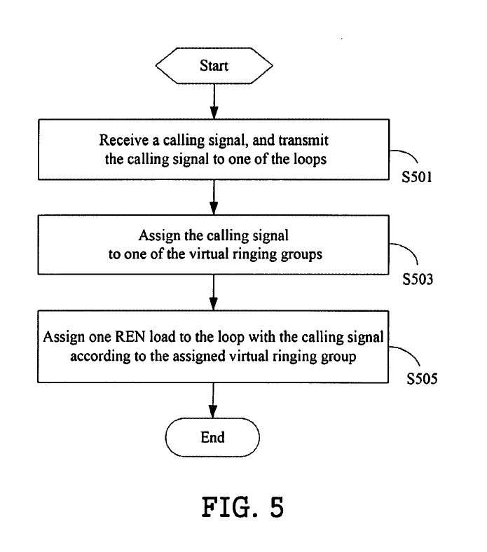

FIG. 5 is a flowchart of a load assigning method of an exemplary embodiment of the present invention.

In step S501, the receiving module 100 receives a calling signal, and transmits the calling signal to one of the loops.

In step S503, the assigning module 102 assigns the calling signal to one of the virtual ringing groups.

In step S505, the ringing module 104 assigns one REN load 106 to the loop with the calling signal according to the assigned virtual ringing group.

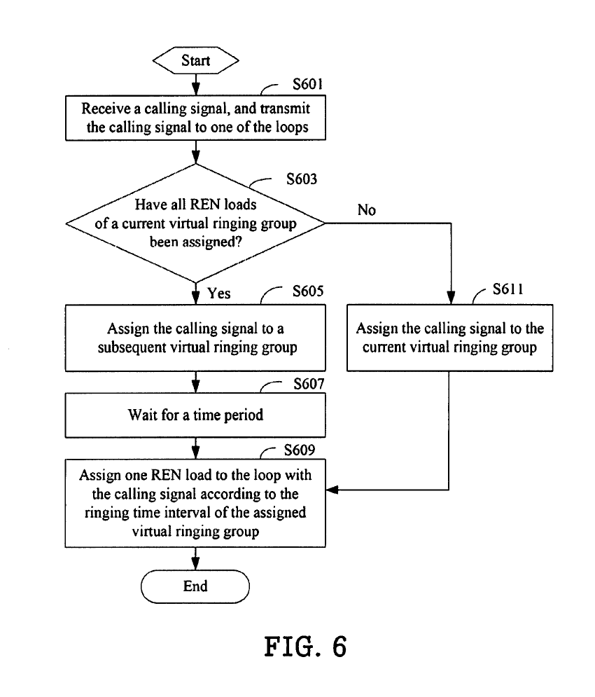

FIG. 6 is a detailed flowchart of the load assigning method of FIG. 5.

In step S601, the receiving module 100 receives a calling signal, and transmits the calling signal to one of the loops. In this embodiment, the network device 10 is a voice gateway.

In step S603, the determining module 1021 determines whether all REN loads 106 of a current virtual ringing group have been assigned.

If not all REN loads 106 of the current virtual ringing group have been assigned, in step S611, the assigning submodule 1023 assigns the calling signal to the current virtual ringing group.

If all REN loads 106 of the current virtual ringing group have been assigned, in step S605, the assigning submodule 1023 assigns the calling signal to a subsequent virtual ringing group.

In step S607, the ringing module 104 waits for a time period. In the exemplary embodiment, the time period is equal to the time difference between a starting time of the ringing time interval of the assigned virtual ringing group and the time when the calling signal is received.

In step S609, the ringing module 104 assigns one REN load 106 to the loop with the calling signal according to the ringing time interval of the assigned virtual ringing group.

In the exemplary embodiment of the present invention, the network device 10 dynamically assigns the REN loads 106 via the virtual ringing groups, so the number of the required REN loads 106 and the total ringing power consumption are effectively reduced.

While various embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A network device adapted for communicating with other network devices with a plurality of loops, the network device comprising:
a plurality of virtual ringing groups each ringing during an individually fixed ringing time interval;
a plurality of Ringer Equivalency Number (REN) loads for generating ringing signals, wherein the number of REN loads is less than that of the loops;
a receiving module for receiving a calling signal and transmitting the calling signal to one of the loops;
an assigning module for assigning the calling signal to one of the virtual ringing groups; and
a ringing module for assigning one REN load to the loop with the calling signal according to the assigned virtual ringing group.

2. The network device as claimed in claim 1, wherein each of the virtual ringing groups comprises a plurality of REN loads.

3. The network device as claimed in claim 2, wherein the assigning module comprises:
a determining submodule for determining whether all REN loads of a current virtual ringing group have been assigned; and
an assigning submodule for assigning the calling signal to one virtual ringing group according to the determined result of the determining submodule.

4. The network device as claimed in claim 3, wherein the assigning submodule is further used for assigning the calling signal to a subsequent virtual ringing group when all REN loads of the current virtual ringing group have been assigned.

5. The network device as claimed in claim 4, wherein the ringing module is also for waiting for a time period, and assigning one REN load to the loop with the calling signal according to the ringing time interval of the assigned virtual ringing group.

6. The network device as claimed in claim 5, wherein the time period is equal to the time difference between a starting time of the ringing time interval of the assigned virtual ringing group and the time when the calling signal is received.

7. A load assigning method used in a network device, the network device communicating with other network devices with a plurality of loops, the load assigning method comprising:
providing a plurality of virtual ringing groups each ringing during an individually fixed ringing time interval, and a plurality of Ringer Equivalency Number (REN) loads for generating ringing signals, wherein the number of REN loads is less than that of the loops;
receiving a calling signal;
transmitting the calling signal to one of the loops;
assigning the calling signal to one of the virtual ringing groups; and
assigning one REN load to the loop with the calling signal according to the assigned virtual ringing group.

8. The load assigning method as claimed in claim 7, wherein each of the virtual ringing groups comprises a plurality of REN loads.

9. The load assigning method as claimed in claim 8, wherein assigning the calling signal to one of the virtual ringing groups comprises:
determining whether all REN loads of a current virtual ringing group have been assigned; and
assigning the calling signal to the current virtual ringing group if not all REN loads of the current virtual ringing group have been assigned.

10. The load assigning method as claimed in claim 9, wherein assigning the calling signal to one of the virtual ringing groups further comprises:
assigning the calling signal to a subsequent virtual ringing group if all REN loads of the current virtual ringing group have been assigned.

11. The load assigning method as claimed in claim 10, wherein assigning one REN load to the loop with the calling signal according to the assigned virtual ringing group comprises:
waiting for a time period; and
assigning one REN load to the loop with the calling signal according to the ringing time interval of the assigned virtual ringing group.

12. The load assigning method as claimed in claim 11, wherein the time period is equal to the time difference between a starting time of the ringing time interval of the assigned virtual ringing group and the time when the calling signal is received.

13. A method for assigning Ringer Equivalency Number (REN) loads in a network device communicable with other network devices via a plurality of loops thereof, the method comprising:
defining a plurality of virtual ringing groups each of which enables a plurality of REN loads of said network device to ring respectively during a corresponding ringing time interval starting differently from another corresponding ringing time intervals for others of said plurality of virtual ringing groups;
receiving a calling signal;
transmitting said calling signal to one of said plurality of loops which has a total number thereof greater than a total number of said plurality of REN loads;
assigning said calling signal to one of said plurality of virtual ringing groups; and
assigning one of said plurality of REN loads to said transmitted one of said plurality of loops with said calling signal to ring according to said assigned one of said plurality of virtual ringing groups.

14. The method as claimed in claim 13, wherein assigning said calling signal to one of said plurality of virtual ringing groups comprises:
determining whether all of said plurality of REN loads of a current virtual ringing group have been assigned; and
assigning said calling signal to said current virtual ringing group if not all of said plurality of REN loads of said current virtual ringing group have been assigned.

15. The method as claimed in claim 14, wherein assigning said calling signal to one of said plurality of virtual ringing groups further comprises:
assigning said calling signal to a subsequent virtual ringing group if all of said plurality of REN loads of said current virtual ringing group have been assigned.

16. The method as claimed in claim 13, wherein said total number of said plurality of loops is a product of said total number of said plurality of REN loads and a total number of said plurality of virtual ringing groups.
